(19) United States
(12) Patent Application Publication
(10) Pub. No.: US 2013/0151350 A1
(43) Pub. Date: Jun. 13, 2013

(54) GRANULAR CONTROL APPLICATION FOR DELIVERING ONLINE ADVERTISING

(71) Applicant: PUBMATIC, INC., Redwood City, CA (US)

(72) Inventors: Ananda KUMAR, Pune (IN); Anand DAS, Pune (IN); Rajeev GOEL, Menlo Park, CA (US); Amar GOEL, Engelwood Cliffs, NJ (US); Mukul KUMAR, Pune (IN)

(73) Assignee: PUBMATIC, INC., Redwood City, CA (US)

(21) Appl. No.: 13/708,435

(22) Filed: Dec. 7, 2012

Related U.S. Application Data
(60) Provisional application No. 61/569,200, filed on Dec. 9, 2011.

(51) Int. Cl. G06Q 30/02

(52) U.S. Cl. CPC G06Q 30/0275
USPC 705/14.71

(57) ABSTRACT

Ad segments on a Web page are filled with ads that are served by a service provider operating between a user computer and publisher on one end and multiple ad serving entities on the other. The service provider implements a bidding process for the ad segment. The winning ad serving entity (DSP, ATD, advertiser, etc.) has its ad delivered to the user browser by the service provider where it is displayed in the Web page. The floor e-CPM for the ad segment is determined by the publisher using data related to the user (demographic, geographic, socio-economic, etc.), information on the ad segment (e.g., location on page), and relationships the publisher (e.g., a DSP having a relationship with the publisher may be offered a lower e-CPM). The service provider provides tools and highly granular information for the publisher in order to create an appropriate floor e-CPM for the ad segment.

### CROSS-REFERENCE TO RELATED APPLICATIONS

This application claims the benefit under 35 U.S.C. §119(e) of U.S. Provisional Patent Application No. 61/569,200, entitled “MANAGING PUBLISHER PREFERENCES FOR ONLINE ADVERTISING FOR MULTIPLE ENTITIES” filed Dec. 9, 2011, which is hereby incorporated by reference in its entirety.

### TECHNICAL FIELD OF THE INVENTION

The present invention relates generally to computer software and Internet advertising. More specifically, the invention relates to software for serving advertisements over the Internet for display on Web sites.

### BACKGROUND OF THE INVENTION

The online advertising industry is growing increasingly sophisticated. As the number of display ads grows, driven mainly by more intelligent programmatic ad buying capabilities, the amount of control that publishers (entities who have an inventory of advertising space to sell) want with respect to selling this ad space inventory grew. And with it the value of the publisher's inventory rose as well. There is an increasing desire among publishers to carve out specific inventory buckets for their ad space inventory. On the advertiser side, advertisers are now increasingly particular about how much they will pay to place their ads on Web pages. Presently, prices for paying for ad space is based on fairly generic level controls, such as Web site traffic, location on Web page, visibility on page, and the like. The specific audience, that is, who would see the ad, does not play a role in determining the value of an ad space or segment.

It would be desirable to provide publishers with greater level of control in determining which ads are served to them for display based on a variety of demographic and other categories. Overall this would also be desirable for the advertisers and entities providing services to advertisers. Advertisers would like to be able to target a specific audience and have the flexibility of paying more or less for a given ad segment depending on who will see the ad.

### SUMMARY OF THE INVENTION

In one aspect of the preset invention, a method of serving an ad to an ad segment on a Web page being viewed by a user is described. The Web page is published by an online publisher, such as a blog site, online retail store, or media company. A user visits a Web site and HTTP is downloaded to the user's browser where it is executed to render the Web site pages. In the HTTP there is a script for an ad which executes. The user computer creates an HTTP call which may contain a user ID and a session ID, retrievable from the user cookie. This HTTP call is sent to a service provider computer. The service provider acts an entity that operates between the publisher and user computer on one end and ad serving entities, such as demand side partners (DSPs), affiliated trading desks (ATDs), actual advertisers, and other entities in the ad industry that provide and deliver ads.

Once the service provider receives the HTTP call, it may retrieve user data relating to the user from its databases using the UID. This user data may contain anywhere from basic demographic data to extensive demographic, geographic, and socio-economic data on the user. The depth and breadth of the data can vary significantly. The service provider then retrieves or receives a minimum or floor effective cost per mil (e-CPM) price for the ad segment. One of the aspects of the present invention is giving the publisher the ability to calculate or derive a floor e-CPM using dozens of variables ranging from the location of the ad segment on the page, extensive information about the user, and relationships the publisher may have with certain ad serving agencies. All these factors can be used to derive specific floor e-CPM prices for publisher's ad segments and done in real time.

The service provider is in communication with numerous ad serving entities and opens a bidding process for filling the ad segment. The floor e-CPM value is broadcasted out to the ad serving entities, including direct advertisers in an effort to get the highest e-CPM bid for the ad segment. The ad serving entities or advertisers are able to make informed decisions about whether to make a bid and for how much since they may be provided with at least basic demographic data and typically more about the user (such as geographic and socio-economic data). They would generally be more willing to pay a higher CPM price if they knew that the user fit the profile of the customer they are targeting. Another factor that may influence the floor e-CPM value is the relationship the publisher has with the advertiser or ad serving entity (DSP, ATD, etc.). Thus, not all ad serving entities are given the same opening bid value. A DSP with a relationship with the publisher may be given a slightly lower opening e-CPM bid than an ATD or other DSP that does not have such a relationship or arrangement with the publisher. Once a winning bidder is determined, the bidder's ad is received by the service provider and then transmitted to the user browser so it can be displayed in the Web page in the ad segment. At this stage the Web page loading process (and the ad script that executed in the HTML) is complete.

### BRIEF DESCRIPTION OF THE DRAWINGS

The invention and the advantages thereof may best be understood by reference to the following description taken in conjunction with the accompanying drawings in which:

FIG. 1 is a block diagram showing the entities and relationships for controlling advertising and setting e-CPM floors in accordance with one embodiment of the present invention;

FIG. 2 is a block diagram showing other entities and interactions for implementing the present invention;

FIG. 3 is a flow diagram of a process of serving an ad to a Web browser when a user has downloaded a Web page in accordance with one embodiment of the present invention. and

FIGS. 4A and 4B are diagrams of a computing device suitable for implementing embodiments of the present invention.

In the drawings, like reference numerals are sometimes used to designate like structural elements. It should also be appreciated that the depictions in the figures are diagrammatic and not to scale.

### DETAILED DESCRIPTION OF THE INVENTION

Methods and systems for enabling a publisher to set floor prices for e-CPMs (“cost per mil”) using granular controls are described in the various figures. As described above, publishers would like to have greater control in determining what types of ads are displayed on its Web pages using a variety of demographic, geographic and other categories. Advertisers want to be able to target specific audiences and have the flexibility of paying more or less for a given ad segment.

In order to describe embodiments of the present invention, we start with the entities and relevant communications among them. As is known in the industry, at one end is the online Web site publisher which has advertising space or segments on its Web pages. Publishers can range from individuals who have, for example, a blog or simply a personal Web site to multinational companies such as news organizations and global online media companies which have vast advertising space over hundreds or thousands of Web pages. Of course, the size of the audiences for these Web sites can vary widely, from a few hundred (or even dozen) unique visitors per month to tens of millions of viewers.

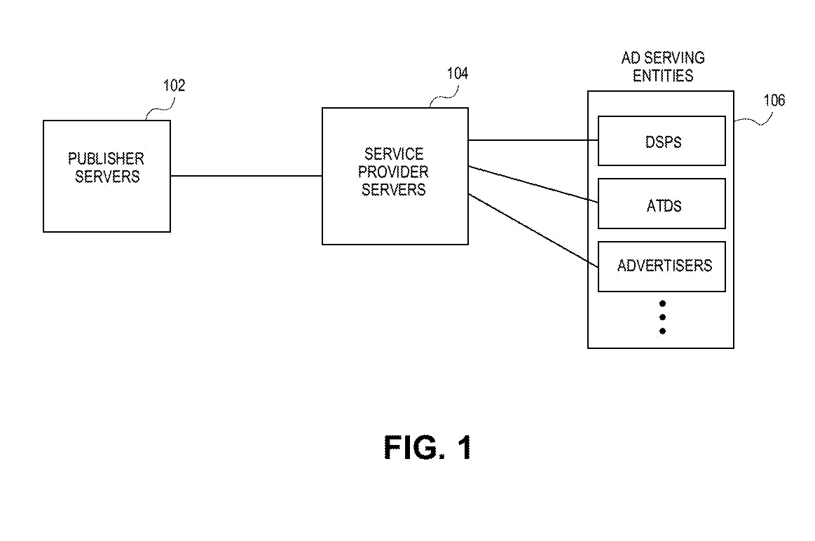

FIG. 1 is a block diagram showing the entities and relationships for controlling advertising and setting e-CPM floors in accordance with one embodiment of the present invention. At one end is a publisher 102, essentially a Web site that has advertising space or segments. The publisher is in communication over the Internet with a third-party service provider 104 which operates one or more server computers that execute operations for implementing the present invention (the Internet is not shown; for illustrative purposes, lines are drawn directly between entities which may indicate direct communication or communication over the Internet). The service provider 104 is in communication with various entities 106 that supply ads, such as demand side partners (DSP), ATDs, trading desks and advertisers, such as Ford, Proctor & Gamble, and Coca-Cola. The service provider communicates directly with these entities. The goal of publisher 102 is to obtain the highest CPM price for each of its advertising segments. The goal of the advertiser or advertising entities 106 is to serve online ads that reach as narrow and targeted an audience as possible; that is, ads that are most effective. In FIG. 1, there is communication between publisher 102 and service provider 104 and communication between service provider 104 and ad serving entities 106.

Generally, if the advertiser is assured that their ad will be seen by the right audience, the advertiser would be willing to pay more for placing the ad. The role of service provider 104 is to facilitate reaching both these goals by acting as an ad serving broker between the two entities (publisher 102 and advertiser 106).

Publishers now want more control in determining minimum (floor) e-CPM prices for their spots. Publishers now want to essentially create or carve out specific ad space inventory buckets. For example, a publisher may have 100 ad spots that it wants to fill. A certain number of the spots, for example 40, are on pages that are most likely viewed by viewers who earn above $80,000 annual income, live in metropolitan areas in the U.S., and may be either male or female. Another 35 spots are likely to be viewed by people between the ages of 18-35 who are interested in sports. Another 23 spots are likely viewed by people ages 55-70, male or female, and interested in travel, and so on. Of course, many more categories can be used to describe these buckets and they can be much more specific. Publishers would like to set a floor e-CPM for each bucket. The floor e-CPM for ad segments in the first bucket described above will be higher than the floor for ad spots viewed by the 18-35 year old sports enthusiasts. The publisher has far more fine grained control over the pricing of its ad spots. It can set floor e-CPMs that are more economically feasible for advertisers and which advertisers are more willing to pay.

From the advertiser perspective, giving the publisher more control over ad serving is also more appealing. An advertiser such as Nike would be more willing to pay a higher floor e-CPM for placing an ad that is more likely to be viewed by people interested in sports and are of a certain age range. Similarly, a luxury brand advertiser is also more likely to pay a higher e-CPM for placing an ad on a page that is more likely to be viewed by male or female viewers having a high annual salary, are between certain ages, and live in metropolitan areas where the luxury brand has stores. There is a wide variety of such advertisers catering to audiences or markets having a specific demographic or socio-economic background, and having other characteristics. Publishers would like to create buckets, each with its own floor e-CPM that can cater to each of these groups.

It is not practical however for publishers 102 to communicate directly with advertisers 106 to obtain the highest e-CPM floor price that the market is willing to pay. The service provider 104 of the present invention facilitates the communication between the publisher 102, Web page user (described below), and the advertisers 108. Some of the larger publishers may also set floor e-CPMs for specific advertisers who are associated with specific ATDs or DSPs who would like to advertise to certain users who have a specific demography and geography. For example, if a user is female, between the ages of 25-35 and lives in London, the publisher will ask for a lower e-CPM if the advertiser is Nike and is through DSP1 and an even lower e-CPM if it is Nike through DSP2.

As is well known in the industry, an ad is served after a user has downloaded a Web page into his browser. The code comprising the Web page (most often HTML) is executed by the browser and the ads are served to the user computing device from the ad source. In the present invention, the entity serving the ad is the service provider 104 which receives it from an ad serving entity 106. When the viewer goes to a Web site and the HTML for the site is executed in the user's browser, the user's cookie is available to the publisher. The cookie is interpreted by the code in the publisher's Web page and then an HTTP call is made to the service provider with certain cookie parameters. Certain information in the cookie is used by the publisher and the service provider to enable serving the most appropriate ad for the ad segments on the Web pages being loaded on the user's computing device. In one embodiment, this information may consist of a user ID (UID) and a system ID (SID).

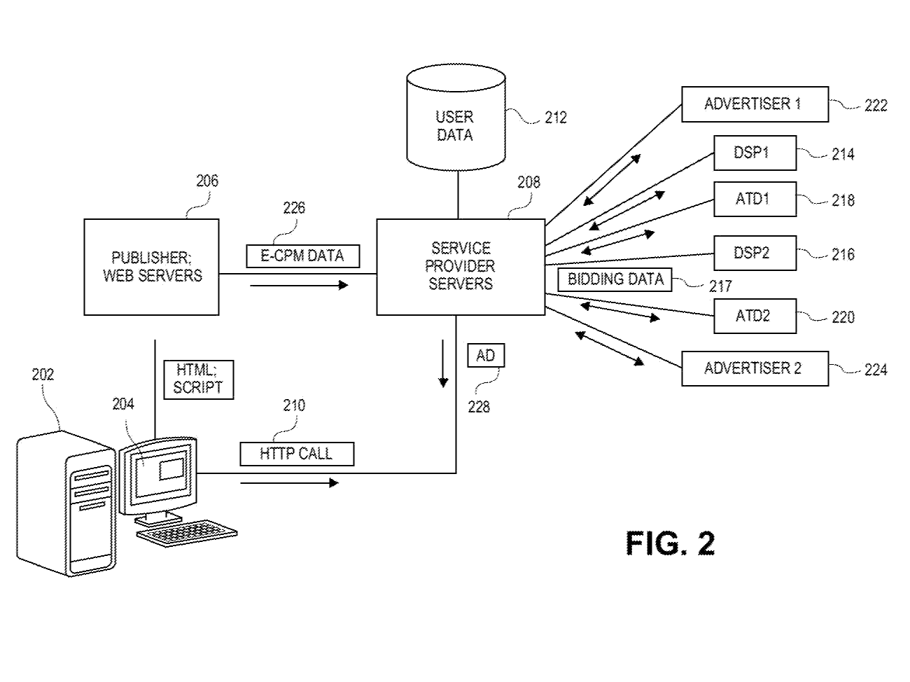

FIG. 2 is a block diagram showing other entities and interactions for implementing the present invention. It shows a user computing device 202 executing a browser 204. The user goes to a certain Web site 206, for example, a blog about traveling. Code for displaying the Web site executes in the user's browser 204. In the code there is a script for displaying an ad. The ad is served by a service provider 208. An HTTP call 210 is made from user computing device 202 to service provider 208 that contains a UID and an SID. The service provider uses the SID and UID to retrieve information on the user. The service provider may have data on more than 500 million unique users (individuals). The data it has on the individuals includes age range, gender, preferences, demographic information, geographic location, socio-economic data (e.g., income, nationality, race, etc.), among other data. The service provider databases 212 may be indexed by UID to obtain user or segment data. This data is searched in real time. As described below, the publisher's Web page is held until the look-up and ad bidding is done. The Web page is displayed when an ad has been selected and is available to be served and displayed with the Web page.

The service provider then places the ad spot for bidding (that is, it starts a bidding process 217). Various types of entities can bid on the spot. For example, DSPs (214 and 216), ATDs (218 and 220), and advertisers (222 and 224) can bid on the ad spot. Audience segment level and ad type level may also be used to derive permutations that can be used by publisher 206 to set floor e-CPMs. These bidders are notified that there is an ad spot available on a travel blog Web site that is being viewed by a user, for example, in the 45-55 age range, living in San Francisco, male, Asian, has an annual income above $55,000, and so on.

The notification also includes a minimum bid price or floor e-CPM for the spot. Customized e-CPM floor prices may be offered for certain advertising entities. For example, if Macy's is placing a bid through Caderon (an ATD), then the floor is $8.50. If Macy's is placing a bid directly, then the floor is $8.90. Other combinations and permutations are also possible. For example, if the user is a certain person and if the advertiser is, for example, Reebok, then the e-CPM for Reebok for the ad spot is lower than it would be for another user. There are many different combinations of DSPs, ATDs, trading desks, and the like. That is one of the primary advantages of the present invention. The service provider gives very granular control to publishers who now have numerous controls that may be used to fill ad spots on Web pages. It is not efficient for publishers to leverage these controls by themselves, even though some of the larger publishers may be able to directly deal with certain advertisers or DSPs (or other ad serving entities), those publishers cannot at a practical level deal with 50 or a 100 ad serving entities and thousands of advertisers in real time to serve ads at e-CPMs that are acceptable to both sides.

There are numerous types of data that can be offered about the user. The service provider 208 may also state some requirements of the publisher 206, such as the quality of the ad (pixels, creatives, etc). The advertising entities (214-224) can then bid on the spot. One of the goals is to obtain a match between user demographic data and features with an ad spot on the Web page. The publisher is able to set floor e-CPMs on numerous permutations of which a few basic examples are described here. A person of skill in the art of online ad serving would know how to take the controls and preferences and create many other types of permutations and appropriate floor e-CPMs. There are also relationships that the publisher may have with DSPs, ATDs, etc. that can be used to set floor e-CPMs. Without the service provider of the present invention, the publisher would not be able to effectively use these controls or use them at all to set e-CPM floors. This is now possible because the publisher has the benefit of the service provider's ability to get a profile of the user/audience viewing the Web site in real-time. Finally, the ad 228 by the winning ad serving entity is served to user Web browser 204 and displayed in the Web page which can then complete loading.

As noted above, the number of parameters and categories that may be used to set floor prices has increased significantly. The service provider is able to obtain and has stored massive amounts of data on hundreds of millions of users in its databases. Because of this large volume of data on users that is now available, the service provider can enable the publisher a level of control in filling its ad spots that was previously not available. This information can be searched and the bidding process can occur as a Web page is loading. Once an ad has been selected (i.e., there is a winning bid), the ad is served by the service provider to the user's browser and displayed on the Web page. That user is now presented with an ad that is very likely of high interest to him or her.

With the present invention, publishers can now ask for floor e-CPMs for ad spots in a more calibrated manner, as described above. For example, a publisher can now ask for various floor e-CPMs 226 for the same advertiser depending on how the ad from that advertiser is served. For example, the publisher may have a flat fee arrangement with a particular trading desk or DSP, so if an ad is served through that entity, the floor e-CPM may be lower than if the advertiser were to serve the ad directly or through another ad serving entity.

As shown above, example embodiments of a service provider application for enabling a publisher to have more granular control over setting e-CPM floor prices for ads served on its Web site are described. In one embodiment, a Floor Rule Engine can be implemented, for example as a module of a system (referred to herein as a service provider Private Marketplace), which allows the publisher to set floor pricing at a granular level. The Floor Rule Engine allows the publisher to set the e-CPM floor price using any combination of different entities. Each such parameter is referred to as a rule. Rules can be prioritized as desired.

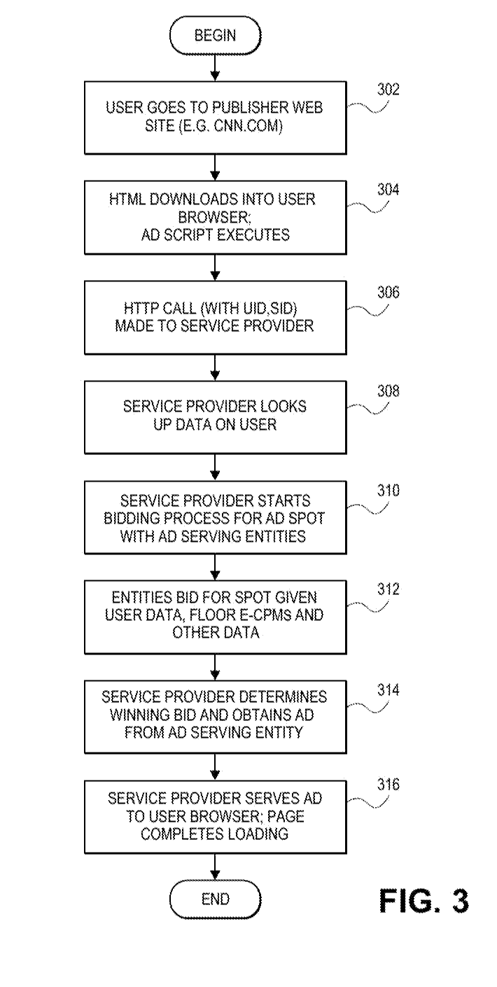

FIG. 3 is a flow diagram of a process of serving an ad to a Web browser when a user has downloaded a Web page in accordance with one embodiment of the present invention. At step 302 a user visits a publisher Web site, such as NYTimes.com or a smaller site as described above. Part of the process of viewing the Web site is downloading HTML and scripts from the publisher Web server into the user's browser as shown at step 304. At this stage the ad script executes in the browser. At step 306 the user computer makes an HTTP call to the service provider servers, as instructed in the ad script. In one embodiment, the HTTP call contains a UID and SID of the user. The service provider uses this data to look up data on the user in the service provider databases. For example, the UID may be used as an index in the database and the UID received can be used to look up information on the user.

At step 310 the service provider, which now has the user data (which may include a wide range of data as described above) and the floor e-CPMs which may be different for different ad serving entities. This and other data may be used in the bidding process initiated by the service provider at step 310. The bidding is opened by the service provider and is broadcasted out to the various ad serving entities. At step 312 the entities receive the bid data (e.g., “ . . . an ad spot on xyz Web site on a specific page to be viewed by this particular user with a floor e-CPM of $n is now available; bidding is open . . . ”) and bid for the ad spot if desired. At step 314 the service provider determines the winning bid for the spot and obtains the ad from the ad serving entity. At step 316 the service provider services the winning ad to the user Web browser so it can be displayed in the downloaded page. At this stage the page downloading is complete. The ad is determined and served by the service provider in real time and is shown in the Web page.

In one embodiment, e-CPM floor prices can be set at any desired granularity or combination of granularities. Examples include:

Demand partner
Advertiser
Campaign
Agency
Trading desk
Seat
Cookie
Audience segment
Geo location
Ad location
Ad Type
Browser
Consumption channel (such as mobile, connected TV, etc.)

Preferences can be varied over dimensions such as:
Publisher level
Publisher site level
Ad tag level
Geography level
Demand partner level
Advertiser level
For example, a publisher can set an e-CPM floor price at any of the following levels—a) ‘agency id’ level, b) audience segment level, c) ‘trading desk’ and ‘audience Segment’ level, d) ‘trading desk’ and ‘audience segment’ and ‘ad type’ (for example rich media) level, and the like.

These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

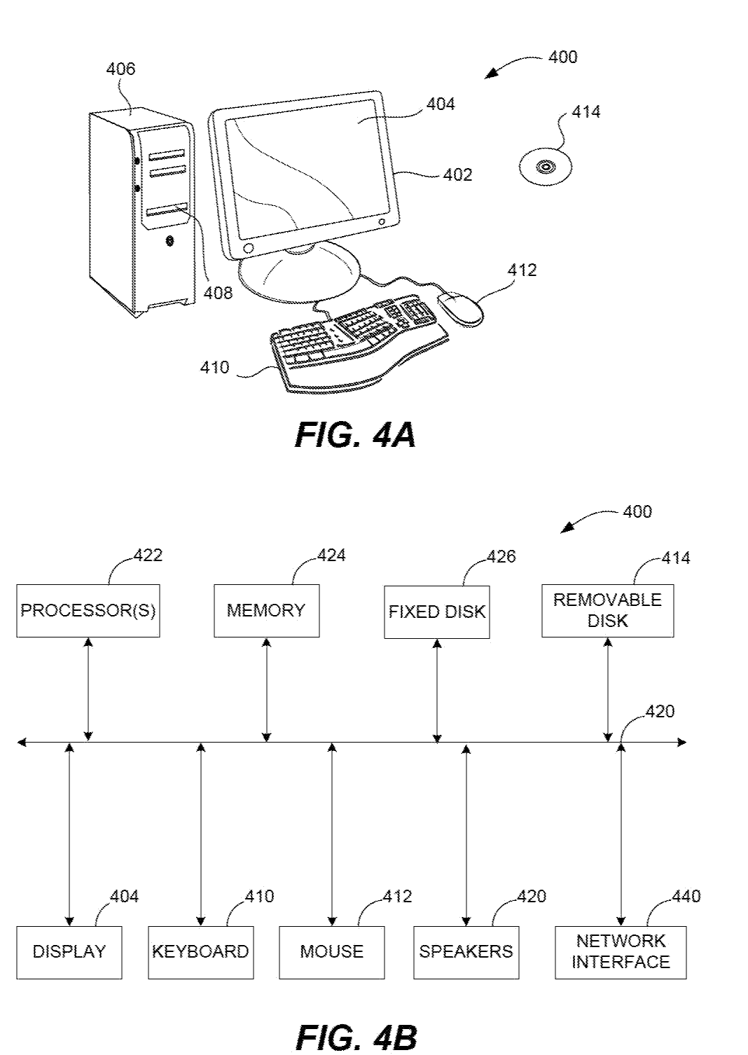

As noted above, the primary computing device in the invention is a user computer executing a browser, one or more service provider server computers, and computers operated by the various ad serving entities and advertisers. The computing devices may also include smart phones, tablet computers, a mobile device, and the like. FIGS. 4A and 4B illustrate a generic computing system 400, suitable for implementing specific embodiments of the present invention. Some of the devices that can be used in the present invention may have other features or components that are not shown in FIGS. 4A and 4B and not all the components shown in these figures (e.g., the keyboard) are needed for implementing the present invention. As such, FIG. 4A shows one possible physical implementation of a computing system as this term is broadly defined.

In one embodiment, system 400 includes a display or screen 404. This display may be in the same housing as system 400. It may also have a keyboard 410 that is shown on display 404 (i.e., a virtual keyboard) or may be a physical component that is part of the device housing. It may have various ports such as HDMI or USB ports (not shown). Computer-readable media that may be coupled to device 400 may include USB memory devices and various types of memory chips, sticks, and cards.

FIG. 4B is an example of a block diagram for computing system 400. Attached to system bus 420 is a variety of subsystems. Processor(s) 422 are coupled to storage devices including memory 424. Memory 424 may include random access memory (RAM) and read-only memory (ROM). As is well known in the art, ROM acts to transfer data and instructions uni-directionally to the CPU and RAM are used typically to transfer data and instructions in a bi-directional manner. Both of these types of memories may include any suitable of the computer-readable media described below. A fixed disk 426 is also coupled bi-directionally to processor 422; it provides additional data storage capacity and may also include any of the computer-readable media described below. Fixed disk 426 may be used to store programs, data and the like and is typically a secondary storage medium that is slower than primary storage. It will be appreciated that the information retained within fixed disk 426, may, in appropriate cases, be incorporated in standard fashion as virtual memory in memory 424.

Processor 422 is also coupled to a variety of input/output devices such as display 404 and network interface 440. In general, an input/output device may be any of: video displays, keyboards, microphones, touch-sensitive displays, tablets, styluses, voice or handwriting recognizers, biometrics readers, or other devices. Processor 422 optionally may be coupled to another computer or telecommunications network using network interface 440. With such a network interface, it is contemplated that the CPU might receive information from the network, or might output information to the network in the course of performing the above-described method steps. Furthermore, method embodiments of the present invention may execute solely upon processor 422 or may execute over a network such as the Internet in conjunction with a remote processor that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

We claim:

1. A method of serving an ad to an ad segment on a Web page being viewed by a user, said Web page published by a publisher, the method comprising:
receiving an HTTP call from a user computer, said call containing a UID and an SID;
retrieving user data relating to the user using the UID, said user data containing demographic data of the user;
retrieving a minimum effective cost per mil (e-CPM) price for the ad segment;
initiating a bidding process with multiple ad serving entities to obtain a highest e-CPM bid for the ad segment; and
serving an ad corresponding to the highest submitted e-CPM to the Web page on the user computer.

2. A method as recited in claim 1 further comprising:
wherein the HTTP call obtains data from a user cookie interpreted by code in a publisher Web page.

3. A method as recited in claim 1 further comprising:
retrieving demographic and geographic data.

4. A method as recited in claim 1 further comprising:
transmitting different opening bid information to multiple ad serving entities.

5. A method as recited in claim 1 wherein the e-CPM received from the publisher is determined based on user demographic data and relationships with ad serving entities.

6. A method as recited in claim 1 wherein a floor e-CPM price for an ad segment is determined by a demographic factor of the user.

7. A method as recited in claim 1 wherein a floor e-CPM price for an ad segment is determined by a geographic factor of the user.

8. A method as recited in claim 1 wherein a floor e-CPM price for an ad segment is determined by a relationship between the publisher and a specific DSP.

9. A method as recited in claim 1 wherein a floor e-CPM price for an ad segment is determined by a relationship between the publisher and a specific ATD.

10. A method as recited in claim 1 wherein a floor e-CPM price for an ad segment is determined by a relationship between the publisher and a specific advertiser.

11. A method as recited in claim 1 wherein a floor e-CPM price for an ad segment is different if the ad is served through a DSP or ATD compared to an ad served directly from an advertiser.

12. A method as recited in claim 1 wherein a floor e-CPM price for an ad segment is different if the ad is served through a specific DSP or through a specific ATD.

13. A method of setting an e-CPM floor price for an ad segment being offered by a publisher, the method comprising:
determining demographic, geographic, and related data on a user viewing a Web page containing the ad segment;
retrieving information on where an ad segment is on the Web page;
evaluating relationships the publisher has with multiple ad serving entities; and
deriving a floor e-CPM price for the ad segment for a specific ad serving entity, wherein the floor e-CPM price is used in an opening bid for filling the ad segment by a service provider in communication with multiple ad serving entities.

14. A method as recited in claim 13 further comprising:
retrieving demographic and geographic data, and socio-economic data on the user as part of a bidding process implemented by the service provider.

15. A method as recited in claim 13 further comprising:
transmitting different opening bid information to the multiple ad serving entities, wherein the opening bid information contains the floor e-CPM price.

16. A method as recited in claim 13 wherein the e-CPM received from the publisher is determined based on user demographic data and relationships with ad serving entities.

17. A method as recited in claim 13 wherein a floor e-CPM price for an ad segment is determined by a relationship between the publisher and a specific DSP.

18. A method as recited in claim 13 wherein a floor e-CPM price for an ad segment is determined by a relationship between the publisher and a specific ATD.

19. A method as recited in claim 13 wherein a floor e-CPM price for an ad segment is determined by a relationship between the publisher and a specific advertiser.

20. A method as recited in claim 13 wherein a floor e-CPM price for an ad segment is different if the ad is served through a DSP or ATD compared to an ad served directly from an advertiser.
